(19) United States
(12) Patent Application Publication
(10) Pub. No.: US 2010/0058216 A1
(43) Pub. Date: Mar. 4, 2010

(54) APPARATUS AND METHOD FOR PROVIDING USER INTERFACE TO GENERATE A MENU LIST

(75) Inventors: Soo Yeoun Yoon, Suwon-si (KR); Keum Koo Lee, Seongnam-si (KR); Hui Chul Yang, Seoul (KR); Yong Jin So, Seoul (KR)

Correspondence Address: H.C. PARK & ASSOCIATES, PLC, 8500 LEESBURG PIKE, SUITE 7500, VIENNA, VA, 22182, US

(73) Assignee: SAMSUNG ELECTRONICS CO., LTD., Suwon-si (KR)

(21) Appl. No.: 12/509,829

(22) Filed: Jul. 27, 2009

(30) Foreign Application Priority Data
Sep. 1, 2008 (KR) 10-2008-0085836

(51) Int. Cl. G06F 3/048

(52) U.S. Cl. 715/769; 715/825

(57) ABSTRACT

The present invention relates to a portable terminal that may generate and provide a menu list connected to and executable between selected function elements in various service area items. A method for providing an interface of the portable terminal includes dividing a screen of the portable terminal into a plurality of service item areas and a menu generation area, and moving, in response to a user request, at least one function element of the service item areas to the menu generation area. The method further comprises generating a menu list executable for the at least one function element of the menu generation area, and displaying the menu list.

### CROSS REFERENCE TO RELATED APPLICATION

This application claims priority from and the benefit of Korean Patent Application No. 10-2008-0085836, filed on Sep. 1, 2008, which is hereby incorporated by reference for all purposes as if fully set forth herein.

### BACKGROUND OF THE INVENTION

1. Field of the Invention

Exemplary embodiments of the present invention relate to a method and apparatus for providing a user interface for generating a menu list connected to and executable when a specific function element among a plurality of service items is moved to a menu generation area.

2. Description of the Background

Use of various portable terminals is rapidly increasing due to fast development and growth in information technology and semi-conductor technology. Portable terminals may now provide several services, such as multimedia service, wireless internet service, local area wireless communications, mobile broadcasting reception, and Social Networking Service (SNS), as well as traditional services such as the voice communications and short message service (SMS). A portable terminal may display various menus and functions of these services on a screen using a user interface (UI).

A large and growing number of functions may be provided by a portable terminal. However, one problem is that each function and associated function elements are separately executed and that each function is executed through a different process and/or in varying order of execution.

### SUMMARY OF THE INVENTION

Exemplary embodiments of the present invention provide a UT which automatically generates a menu list connected to and executable based on user-selected function elements moved to a menu generation area.

Additional features of the invention will be set forth in the description which follows, and in part will be apparent from the description, or may be learned by practice of the invention.

Exemplary embodiments of the present invention disclose a method of providing a menu generation interface of a portable terminal. The method comprises dividing a screen (e.g., display) of the portable terminal into a plurality of service item areas and a menu generation area, and moving, in response to a user request, at least one function element of the service item areas to the menu generation area. The method further comprises generating a menu list executable for the at least one function element in the menu generation area and displaying the menu list.

Exemplary embodiments of the present invention disclose an apparatus having a menu generation interface. The apparatus comprises a display and a controller. The display comprises a screen divided into a plurality of service item areas and a menu generation area. The controller moves at least one function element of the service item areas to the menu generation area in response to at least one user request. The controller generates and displays a menu list executable for the at least one function element of the menu generation area.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the principles of the invention.

FIG. 1 illustrates a schematic configuration of a portable terminal according to exemplary embodiments of the present invention.

FIG. 2A, FIG. 2B, and FIG. 2C are examples of a UI screen illustrating a menu generation screen according to exemplary embodiments of the present invention.

FIG. 3A, FIG. 3B, FIG. 3C, FIG. 3D, and FIG. 3E are examples of a UI screen illustrating a process of generating a menu list according to exemplary embodiments of the present invention.

FIG. 4 is a flowchart illustrating a method of generating a menu list according to exemplary embodiments of the present invention.

### DETAILED DESCRIPTION OF THE ILLUSTRATED EMBODIMENTS

The invention is described more fully hereinafter with reference to the accompanying drawings, in which exemplary embodiments of the invention are shown. This invention may, however, be embodied in many different forms and should not be construed as limited to the exemplary embodiments set forth herein. Rather, these exemplary embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

The terminology used herein is for the purpose of describing particular example embodiments and is not intended to be limiting of the present invention. As used herein, the singular forms “a,” “an” and “the” can include the plural forms as well, unless the context clearly indicates otherwise. It will be further understood that the terms “comprises” and/or “comprising,” when used in this specification, can specify the presence of stated features, integers, steps, operations, elements, and/or components, but do not necessarily preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Prior to describing the exemplary embodiments of the present invention, terminologies will be defined for the description below.

An ‘area’ may refer to one or more areas indicating a plurality of service items. and a menu generation area for generating a menu list. A screen (e.g., display) of the portable terminal may be divided into a plurality of service item areas and the menu generation area.

A ‘service item’ may refer to a representative group of function elements provided by a portable terminal. Here, ‘function element’ may refer to a unit which indicates functions included in each service item. The function element may be represented as an icon and provided to the screen.

The service item may include Contacts, Contents, Web, and Applications. For example, a function element (e.g., contact information of a contact) of the Contacts service item may be stored in the phone book of the portable terminal. The contact information can include, but is not limited to, a home phone number, a portable terminal phone number, an address book, and a date of birth associated with an acquaintance or contact of the portable terminal user.

Contents may refer to a variety of information or contents that can be used in the portable terminal. For example, the contents can include function elements such as a music file, a picture file, and/or a text file.

The Web may include, for example, SNS and other networking web-based applications. The web may provide access to an online community (e.g., facebook, youtube), and an internet browser for accessing the internet.

Applications can include application programs for sending a text message, sending an e-mail, making a phone call, viewing the contact information, viewing updated text, executing a file, and downloading and uploading content from the web.

‘Menu generation area’ may refer to an area for providing an executable menu list on the portable terminal screen. Function element icons within each service item may be dragged and dropped in the menu generation area. The menu generating area may be connected to each dragged and dropped function elements and may generate the executable menu list.

The portable terminal may refer to a terminal in which each function element may be connected and in which the executable menu list may be generated. Examples of the portable terminal include, but are not limited to, a mobile phone, the Personal Digital Assistant (PDA), the Code Division Multiple Access (CDMA) terminal, the Wideband Code Division Multiple Access (WCDMA) terminal, the Global System For Mobile Communication (GSM) terminal, the International Mobile Telecommunication 2000 (IMT-2000) terminal, the Smart phone terminal, and the Universal Mobile Telecommunication System (UMTS) terminal.

Hereinafter, embodiments of the present invention will be explained in detail with reference to the accompanying drawings.

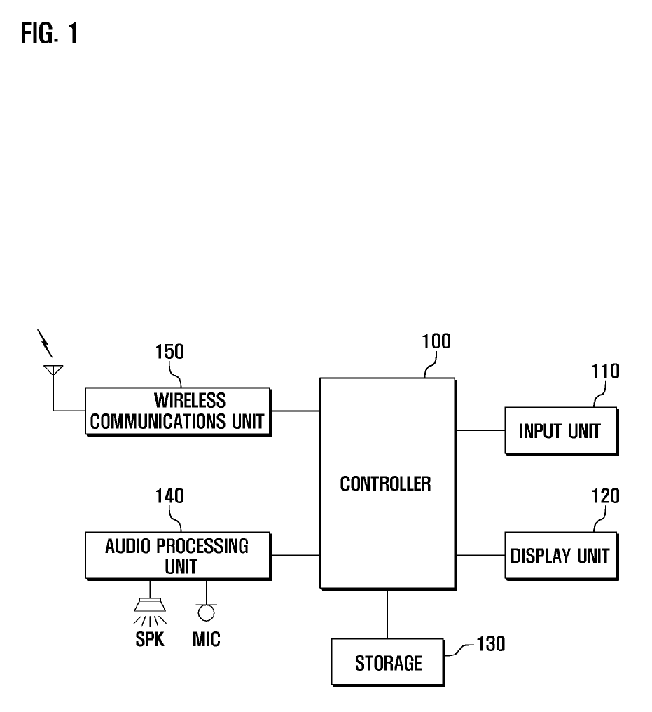

FIG. 1 illustrates a schematic configuration of a portable terminal according to exemplary embodiments of the present invention.

Referring to FIG. 1, the portable terminal may include a controller 100, an input unit 110, a display unit 120, a storage 130, an audio processing unit 140, and a wireless communications unit 150.

The input unit 110 may include a plurality of input keys and function keys for receiving number or character information (e.g., alphanumeric input) and for setting various functions. Function keys can include a direction key, a side key, a shortcut key, a selection key, a move key, and a scroll wheel. The input unit 110 can be configured with a touch screen. In some cases, the input unit 110 may also be the display unit 120. The input unit 110 may send, to the controller 100, a key signal, input in connection with a user setting and the function control of the portable terminal.

For example, the input unit 110 may send, to the controller 100, a drag-and-drop input signal when a function element icon within a service item area is moved to the menu generation area. In particular, the input unit 110 may select the function element icon through the direction key and the selection key, and may send, to the controller 100, an input signal corresponding to the move key which moves the selected icon to the menu generation area.

The display unit 120 may be instructed by the controller 100 to display a menu of the portable terminal, user data input by the user, function setting information, and various other content and information. The display unit 120 may be a display device such as, for example, a Liquid Crystal Display (LCD), and may include Organic Light Emitting Diodes (OLEDs). In some cases, the display unit 120 may be a touch screen and may operate, at least in part, as the input unit 110.

The display unit 120 can input graphic information and/or a command that the user provides by generating a voltage or a current signal corresponding to the location in which a touch panel of touch screen is pressed down. In the touch screen, a touch panel, a liquid crystal panel, and/or a back light may be successively laminated.

Moreover, the touch screen can further include a signal line which may supply a signal from the touch panel to the controller 100, and a Tape Carrier Package (TCP) which may be connected to the lower substrate of liquid crystal panel and may apply an electric signal to a driving unit of the liquid crystal panel.

When a drag-and-drop event is generated, the display unit 120 may send a drag-and-drop input signal to the controller 100. Moreover, the display unit 120 may send a coordinate corresponding to a location where the drag-and-drop event was initiated and terminated, to the controller 100. That is, a voltage or a current signal corresponding to the location in which the touch screen is pressed down and/or the location where the touch screen is no longer pressed may be sensed and the corresponding coordinates may be sent to the controller 100.

A drag event may be generated when an area in which a function element icon in a service item area of the display unit 120 is pressed down, and the icon of the pressed area is continuously moved. When the drag event is generated, the display unit 120 may send the coordinates of the area which is moved to the controller 100.

A drop event may be generated when the drag event is terminated. For example, a drop event may be generated when the user discontinues pressing the pressed area (e.g., function element icon) after moving the pressed area. Accordingly, if the drop event is generated, the display unit 120 may send the coordinates of the area which is no longer pressed to the controller 100.

The storage 130 may store a plurality of data and applications, which in some cases, may be needed for operation of the portable terminal. The storage 130 may include a program area and a data area. Programs related to generation of a menu list, booting the operating system (OS), and function elements moved to the menu generation area may be stored in the program area of storage 130.

The data area may be an area which stores data generated according to the use of the portable terminal, and stores a menu list which is connected to and executable between data of function elements that have been moved to a menu generation area. If a function key signal is input from the menu generation area, the menu list stored in the storage 130 may be deleted by the controller 100.

The audio processing unit 140 may generate an audio signal output from the controller 100 and/or may transmit the audio signal, such as, for example, a voice input from the microphone MIC to the controller 100. The audio processing unit 140 may convert and output voice and audio data into an audible sound through a speaker (SPK) that may be controlled by the controller 100. The audio processing unit 140 may convert an audio signal such as, for example, a voice received from a microphone (MIC) into data to output.

The wireless communications unit 150 may form a communications channel between a portable terminal and a base station, and may manage a series of communications. The wireless communications unit 150 may include a Radio Frequency (RF) transmission unit to up-convert and amplify a frequency of a transmitted signal and a RF receiver, which low-noise amplifies a received signal and down-converts a frequency of the received signal. Particularly, the wireless communications unit 150 may communicate between the portable terminal and the base station to wirelessly access the internet.

The controller 100 may control a signal flow between the overall operation of the portable terminal and the internal components (e.g., storage 130, display unit 120, etc) of the portable terminal. Particularly, the controller 100 may sense an input signal for execution of the menu generation mode by the input unit 110. When the menu generation mode is performed, the controller 100 may classify and display the service item areas and the menu generation area (which may include function element icons) in the display unit 120.

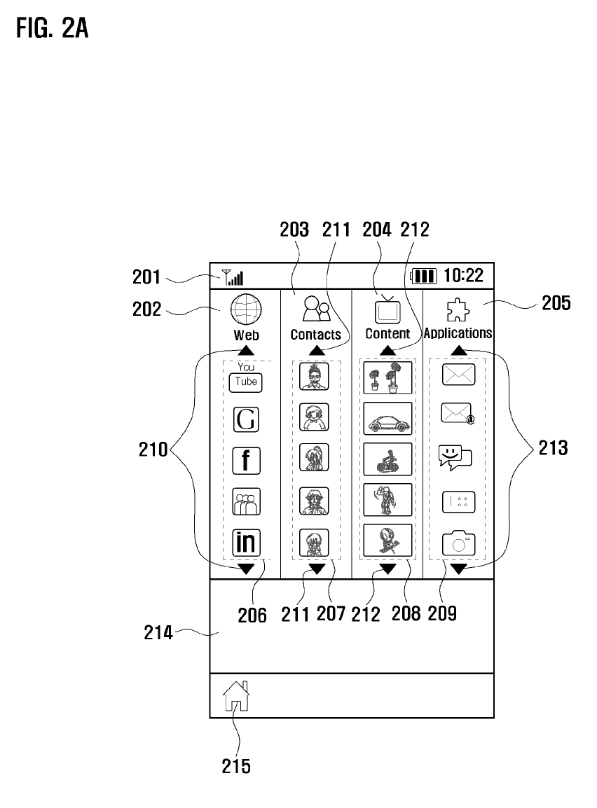

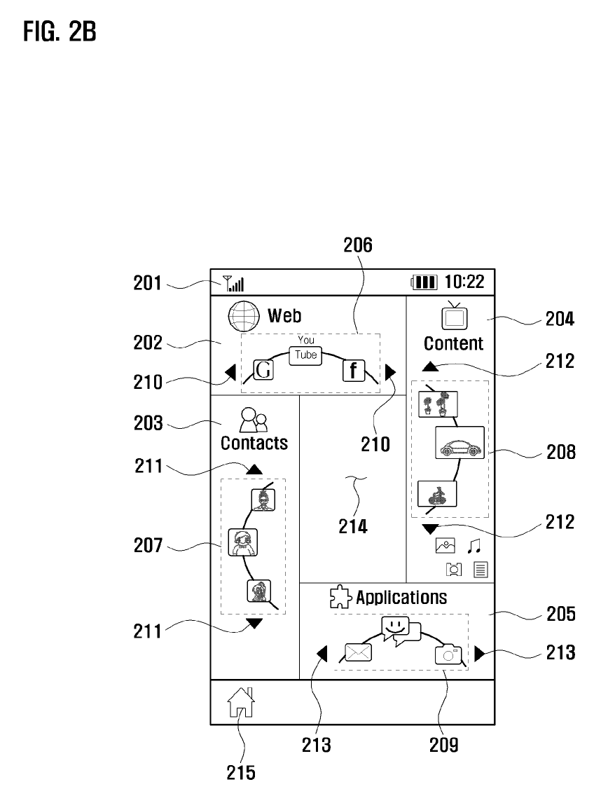

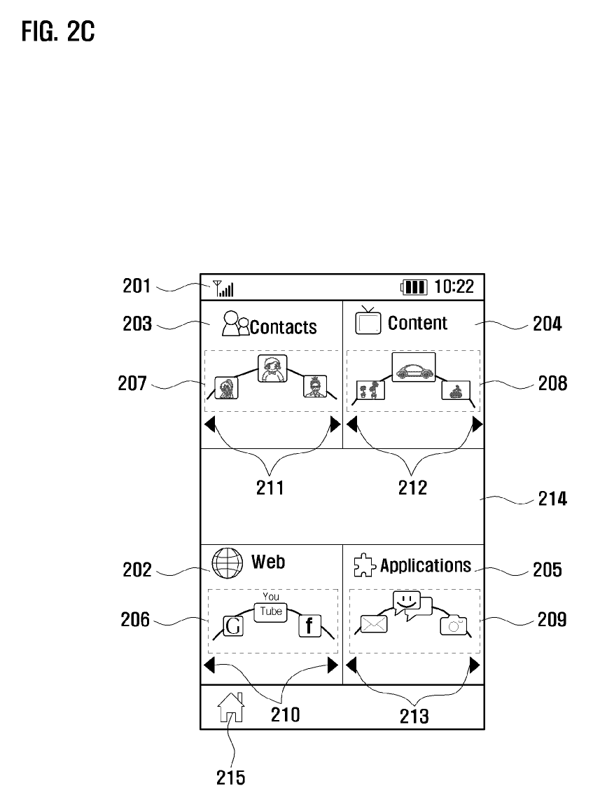

The controller 100 can change the location of each service item area according to user input. For example, the portable terminal user can select a desired screen arrangement among the screen arrangements for executing the menu generation mode. Various suitable screen arrangements may be implemented in the portable terminal, for example, as shown in FIG. 2A, FIG. 2B, and FIG. 2C.

The controller 100 may sense function element icons corresponding to particular service item areas in the menu generation area. For example, the controller 100 may sense that function element icons have moved from a service item area to the menu generation area through the drag-and-drop input. The controller 100 may select function element icons of each service item through the direction key and the selection key, and can sense input of the move key to move the selected icons to the menu generation area.

The controller 100 may sense the input signal for generating a menu list connected to and executable between function elements moved to the menu generation area. For example, the controller 100 may sense an input signal through the input unit 110 of the set up key and a movement-complete signal associated with function element icons. For example, a movement-complete signal may be sensed by the controller when a function element icon has been moved to the menu generating area. The combination of the input signal of the set up key and the movement-complete signal may be designated as a menu list generation input signal. When the menu list generation input signal is sensed, the controller 100 may generate a menu list.

The menu may be connected to and executable between function elements of each service item in the menu generation area. If the menu is not connected to and executable between the function elements in the menu generation area, the controller 100 may display a message to the display unit 120 using a pop-up type window displaying a message such as, for example, “Menu list connected to and executable between corresponding function elements does not exist. Please select icon again.”

When the menu list is connected to and executable between function elements in the menu generation area, the controller 100 may direct the display unit 120 (e.g., screen) to display the generated menu list. For example, the controller 100 can generate a menu list which is connected to and executable between function elements in the Content and the Contacts service area items.

The controller 100 can control when a menu list is displayed in the display unit 120. The menu list may include menus, such as, for example, Sending Image File to Contact Information, Sending Video File to Contact Information, Sending Music File to Contact Information, Attaching Tag of Contact Information to Contents, Adding Contents to Contact Information, and Changing Contents to Contact Information. One or more menus may be displayed in the menu list. The controller 100 can sense a menu list generation input signal for a function element in the menu generation area. For example, the controller 100 can generate and instruct the display unit 120 to display a menu list for a function element moved from the Contents service item area.

The controller 100 can instruct the display unit 120 to display a menu list, which may include menus, such as, for example, Playing Contents, Inputting Contents Tag Information, Viewing Related Contents, Sending Short Message, Sending E-mail, Contents Uploading, Contents Downloading, and Moving to Contents Positioned Website. The controller 100 may perform a function if a selection key or cancel key among the menu list is input by the user. The controller 100 may execute a menu selected by the user from among the generated menu list. If a selected menu is executed, the controller 100 may display an application screen applying one or all of the functions associated with the function elements existing within the menu generation area.

For example, if the Sending Short Message menu is selected from the menu list generated by a connected relationship of a contact and a picture file (i.e., a first function element icon (contact name) from the Contacts service item area and a second function element icon (a picture file) from the Content service item area may be dragged into the memory generation area), the controller 100 may control the application screen for the Sending Short Message menu to display in advance the functions that may be performed according to an execution procedure. For example, a function specifying input of a contact and/or name to whom the message may be sent and a function specifying attachment of a photograph may be displayed. Before or during execution, if a cancel key signal is sensed in the screen displaying the menu list, the controller 100 may remove the menu list from the menu generation area or the pop-up window, and may generate a new menu list which is connected to and executable between function elements moved to the menu generation area after selection of the Sending Short Message menu.

FIG. 2A, FIG. 2B, and FIG. 2C are examples of a UI screen illustrating a menu generation screen according to exemplary embodiments of the present invention.

Referring to FIG. 2A, FIG. 2B, and FIG. 2C, the display unit 120 may include an indicator 201, service item areas 202, 203, 204, and 205, a menu generation area 214, and a home key 215. Service item areas 202, 203, 204, and 205 can include a function element icons 206, 207, 208, and 209 and an up/down arrows 210, 211, 212, and 213.

The indicator 201 may indicate a status of the portable terminal. The status may indicate a status of, for example, the received signal strength of portable terminal, the battery, the current time, and/or processing of a function of the portable terminal.

Service item areas 202, 203, 204, and 205 may include a Web service item area 202, a Contacts service item area 203, a Content service item area 204, and an Applications service item area 205. A service item other than the four service items identified above can be added using a function of the portable terminal.

Web service item area 202 may include function elements 206, such as SNS, which may facilitate networking between a user and user acquaintances/contacts. The web service item area 202 may provide access to online networking communities (e.g., facebook, youtube), and internet browsers for accessing the internet.

The Contacts service item area 203 may include function elements 207 corresponding to the contact information of acquaintances/contacts in the phone book of the portable terminal. Contact information may include information such as the home phone number, the portable terminal telephone number, the address book, and/or the date of birth of the user's acquaintances/contacts. It should be understood that the contact information may include various other data and information, for example, an image corresponding to a user contact.

The Content service area 204 can include function elements 208, such as, for example, a music file, a picture file, and/or a text file. The Applications service item area 205 can include function elements 209 that may provide links to application programs, such as Sending Short Message, Sending E-mail, Viewing the Opponent Information, Viewing the Updated Text of Website, Executing File, and Downloading and Uploading. Function elements 206, 207, 208, and 209 may be represented as icons.

If a number of function elements included in each service item is so numerous that the function elements cannot be displayed in the divided screen area, the up/down arrows 210, 211, 212, and 213 (e.g., scroll bar) may indicate existence of the function element icons not displayed on the screen. The up/down arrows 210, 211, 212, and 213 may be utilized to access the function element icons not displayed on the screen. For example, if one of the up/down arrows 210, 211, 212, and 213 is pressed, a function element icon not displayed on the portable terminal screen may then be displayed and may appear on the screen of the portable terminal.

Function element icons may be dragged and dropped, according to the drag-and-drop input procedure described above, into the menu generation area 214. The functions associated with each dragged and dropped icon may be executed and the execution may be displayed on the screen. For example, function elements of each service item area 202, 203, 204, and 205 may be selected by the user and moved in the menu generation area 214. If the touch signal is inputted to the menu generation area 214, a menu list associated with the function elements may be generated and displayed.

If icon movement is sensed and a touch signal is input for an extended period of time, the menu generation area 214 can provide the user with a help function, which may indicate that input for the generation of a menu list completed. When the home key 215 is selected and/or pressed, the display unit 120 may display the previous screen, a stand-by screen, or a user-selected screen.

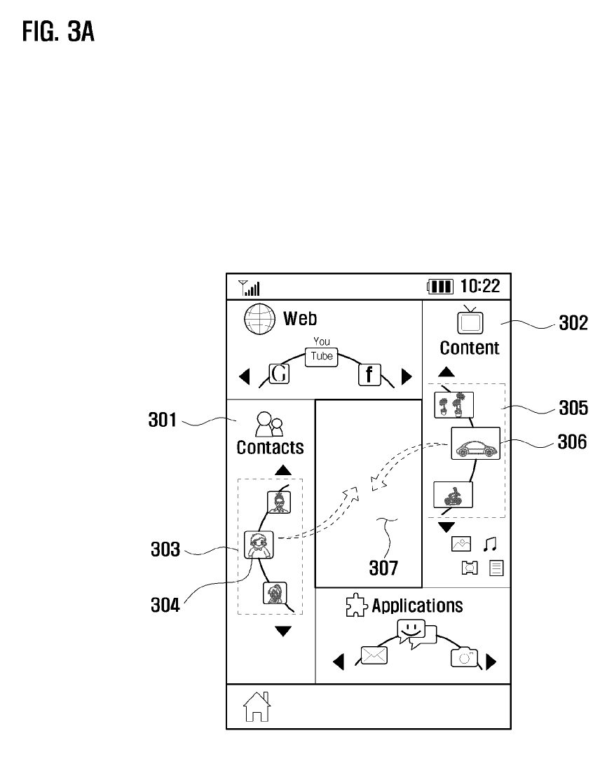

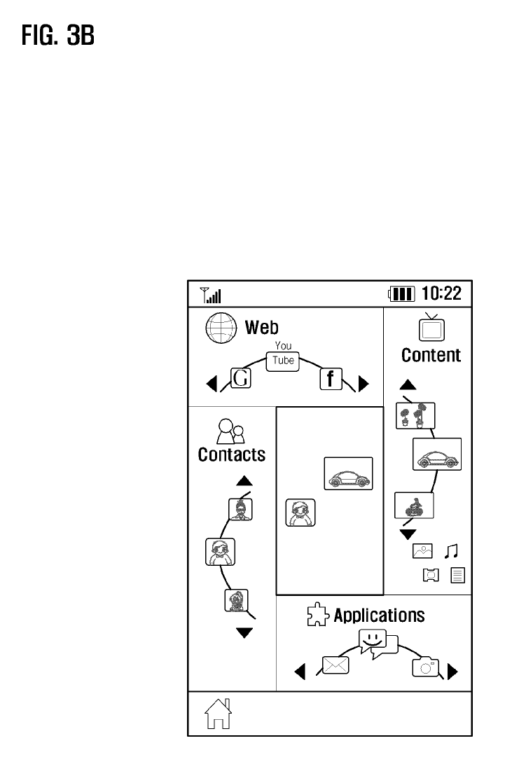

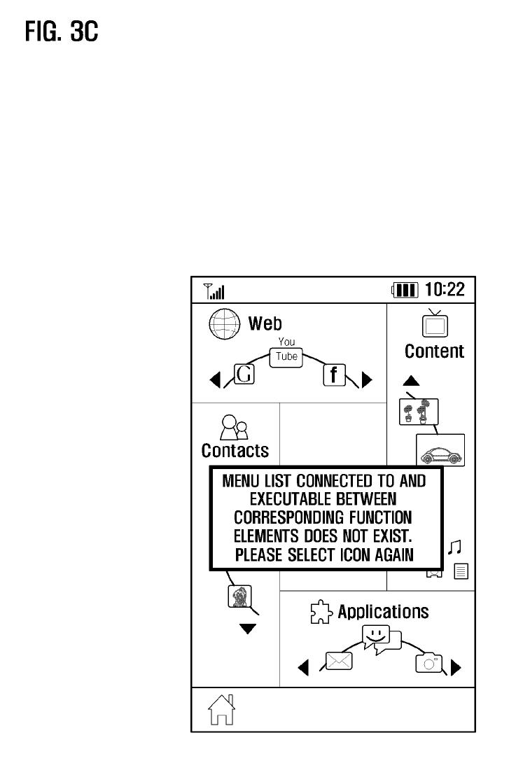

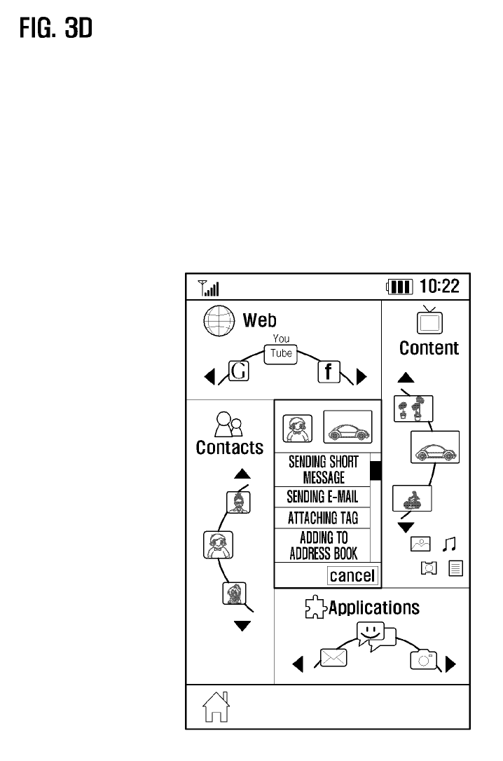

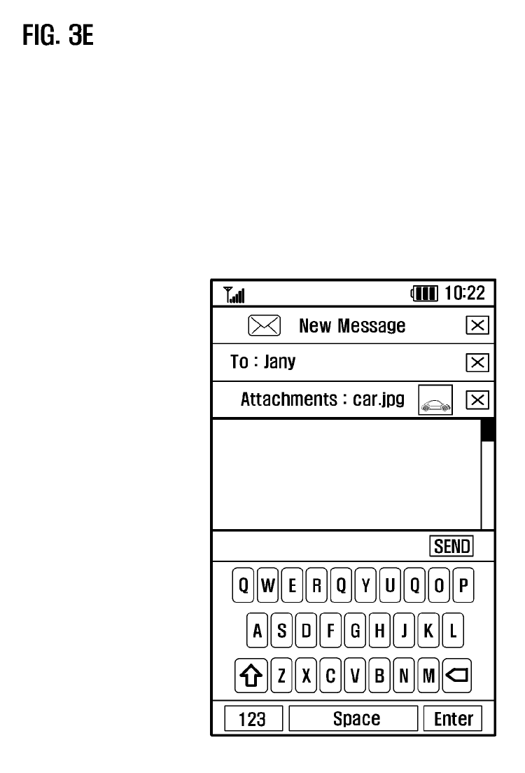

FIG. 3A, FIG. 3B, FIG. 3C, FIG. 3D, and FIG. 3E are examples of screens illustrating the process of generating a menu list according to exemplary embodiments of the present invention.

Referring to FIG. 3A, FIG. 3B, FIG. 3C, FIG. 3D, and FIG. 3E, the controller 100 may sense selection of icon 304 among the function element icons 303 of the Contacts service item area 301. Icon 304 may be associated with the user's acquaintance/contact's contact information. Moreover, the controller 100 may sense selection of a picture file icon 306 among function element icons 305 in the Content service item area 302.

As shown in FIG. 3B, the controller 100 may sense that icon 304 and one picture file icon 306 may be dragged and dropped to the menu generation area 307. The user may use the direction key and the selection key to move the icon 304 and picture file icon 306 to the menu generation area.

The exemplary embodiment illustrated in FIG. 3B is provided by way of example. It should be understood that function elements of other service items may be selected and executed, and that various types of service items and function elements may be provided in a portable terminal.

The controller 100 may sense a moving completion signal of the function elements in the menu generation area, and may generate a menu list connected to and executable between the moved function elements. For example, as shown in FIG. 3D, the controller 100 can generate a menu list including menus, such as, for example, Sending Short Message, Sending E-mail, Attaching Tag and Adding to Address Book. The menus on the menu list may be connected to and executable between the contact information of an acquaintance/contact and a picture file.

The controller 100 can generate a menu list including menus such as, for example, Accessing Corresponding Contact's Website, Viewing New Contents Uploaded to Contact's Website, Uploading Text to Contact's Website, Writing in Guestbook on Contact's Website, Sending Memo to Contact's Website, Sending Web Recommendation Mail, and/or Short Message to Contact. The menu list may include menus which may be connected to and executable between the contact and the website.

The controller 100 may generate an executable menu list for a function element moved to the menu generation area. The executable menu list can include menus, such as, for example, Playing Contents, Inputting Contents Tag Information, Viewing Related Contents, Sending Short Message, Sending E-mail, Uploading Contents, Downloading Contents, and Moving to Contents Positioned Website. If the all the menus in the generated menu list cannot be displayed simultaneously in the menu generation area, a scroll bar may be used to display the menus that could not be displayed.

When a menu associated with a moved function element icon does not exist, the controller 100 may display a message in, for example, a pop up window displaying a message “Menu list connected to and executable between corresponding function elements does not exist. Please select icon again,” as shown in FIG. 3C, to inform a user that the menu list cannot be generated.

The controller 100 may execute a menu selected from among the menu list displayed on the display unit 120. For example, as shown in FIG. 3E, the controller 100 can perform the function of Sending Short Message. The controller 100 may control the application screen of Sending Short Message in such a manner that the functions associated with Sending Short Message may be executed in advance and displayed. For example, a message indicating an intended receiver (e.g., Jany) of the short message and having a picture attachment file (e.g., car.jpg) may be generated and displayed automatically thereby reducing the number of steps a user may need to perform to send short message menu and/or to execute the short message menu. The intended message recipient may correspond to the selected contact person. The automatic generation of a short message by merely dragging two icons may provide greater convenience and speed to a portable terminal user.

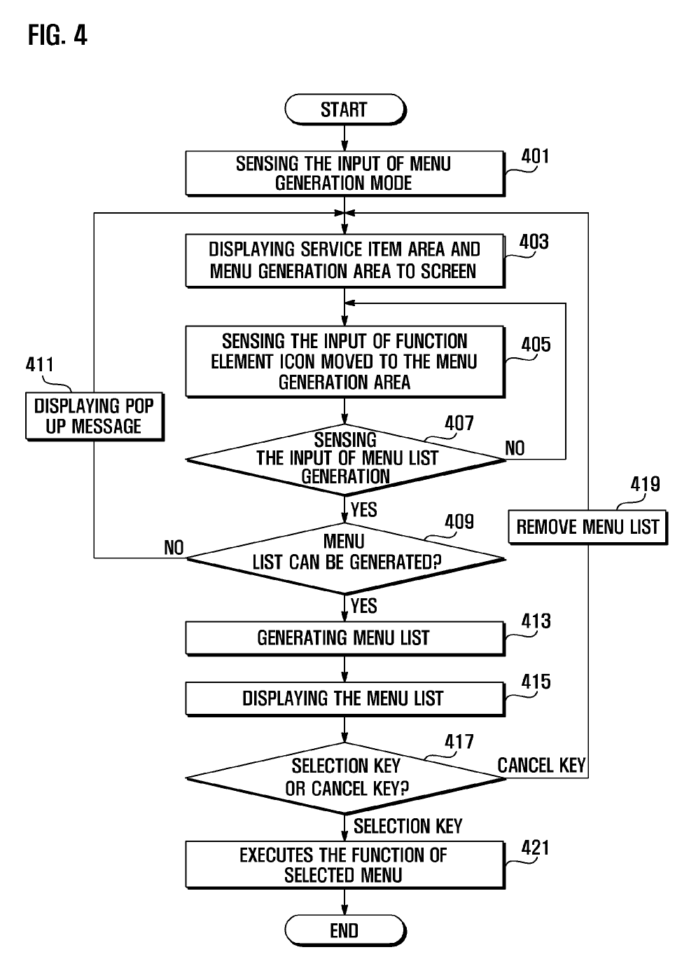

FIG. 4 is a flowchart illustrating a method of generating a menu list according to exemplary embodiments of the present invention.

Referring to FIG. 4, the controller 100 may sense a signal of menu generation mode inputted from a user (401). If the signal of menu generation mode is sensed, the controller 100 may classify and display each service item area and the menu generation area on the screen of the display unit 130 (403).

For example, as shown in FIG. 2A, FIG. 2B, and FIG. 2C, the controller 100 can display a few different displays of the menu generation mode screen which may be set by the user. The controller 100 may display the function elements of each service item with an icon. The controller 100 may sense a drag-and-drop signal associated with function element icons moved from a service item area to the menu generation area (405).

For example, as shown in FIG. 3A, after receiving user input, the controller 100 may move an icon 304 associated with the user's acquaintance/contact's contact information, and the controller 100 may sense a drag-and-drop signal indicating movement of the icon 304 to the menu generation area 307. The controller 100 may also after receiving user input, move a picture file icon 306 among function elements 305 of the Content service item area 302 and the controller 100 may sense a signal indicating movement of the picture file icon 306 to the menu generation area 307.

If the controller 100 moves a function element icon (of a first service item) that had been moved to the menu generation area to another (i.e., a second) service item area, a user may be notified, using a message in pop up type window, that the moved function element icon may not be provided. Moreover, before a signal for menu list generation may be input, the controller 100 can return the function element icons moved to the menu generation area to the area of corresponding service item. The controller 100 may sense the menu list generation input signal via user input (407).

When the menu list generation input signal is sensed, the controller 100 may determine whether a menu list which is connected to and executable between function elements corresponding to the icons positioned in the menu generation area can be generated (409).

If the signal input for the menu list generation is not sensed, the controller 100 may sense input of function elements associated with other service items for moving to the menu generation area at step 405. If the menu list generation is possible, the controller 100 may generate a menu list connected to and executable between the function elements in the menu generation area (413).

If a signal completing movement of function element icons of each service item is input, the controller 100 may determine that a signal for menu list generation has been input. If the menu list connected to and executable between function elements corresponding to the icon moved to the menu generation area does not exist, the controller 100 may inform the user that the menu list cannot be generated through a message of pop up type window (411).

For example, as shown in FIG. 3C, the controller 100 may instruct the display unit 120 to display a message “Menu list connected to and executable between function elements does not exist. Please select icon again.” The controller 100 may then display the service item areas and the menu generation area on the display unit 120 as in step 403, and may repeat steps 403 to 409. If the menu list can be generated, the controller 100 may instruct the display unit 120 to display the menu list in the menu generation area (415).

For example, as shown in FIG. 3D, the controller 100 can display the menu list such as Sending Short Message, Sending E-mail. Attaching Tag, and Adding to Address Book. Each menu may be connected to and executable between the contact information of the user's acquaintance/contact acquired from the Contacts service item area and the picture file of the Content service item area. Moreover, the controller 100 may generate a menu list which may be executable with respect to the function element that was moved to the menu generation area among other function elements included in the service item area. Here, the menu list can include Playing Contents, Inputting Contents Tag Information, Viewing Related Contents, Sending Short Message, Sending E-mail, Contents Uploading, Contents Downloading, and Moving to Contents Positioned on Website. If the menu list is displayed, the controller 100 may sense a menu selection input signal among the displayed menu list (417).

The controller 100 may execute the menu selected by the user through a touch input (421). For example, if the menu of Sending Short Message is selected, as shown in FIG. 3E, the controller 100 may perform the function(s) for sending a short message.

If the cancel key is input when the menu list is displayed, the controller 100 may remove the displayed menu list from the menu generation area or the pop-up window (419). The controller 100 may then return to the display unit 120 displaying the menu generation area and the service item areas as in step 403, and may repeat steps thereafter to generate a menu list as described above.

Accordingly, as described hereinabove, a portable terminal may generate a menu list and/or a menu connected to and executable between function elements selected from various service items. The menu list may be provided to a UI in the menu generation area of the portable terminal and a user may simply select a menu from the menu list. The method and apparatus described hereinabove provides greater convenience, simplicity, efficiency, and speed to the portable terminal user.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A method of providing a menu generation interface of a portable terminal, the method comprising:
dividing a screen of the portable terminal into a plurality of service item areas and a menu generation area;
moving, in response to a user request, at least one function element of the service item areas to the menu generation area;
generating a menu list executable for the at least one function element; and
displaying the menu list.

2. The method of claim 1, wherein generating a menu list comprises:
extracting a relationship between a first function element and a second function element of the at least one function element; and
generating a menu list executable according to the relationship.

3. The method of claim 1, wherein generating a menu list comprises:
generating the menu list for the at least one function element when a movement complete signal for the at least one function element is sensed.

4. The method of claim 1, wherein moving at least one function element comprises sensing a drag-and-drop signal associated with the at least one function.

5. The method of claim 1, wherein the at least one function element is moved to the menu generation area by an input of a function key.

6. The method of claim 1, wherein displaying the menu list comprises displaying the menu list within the menu generation area.

7. The method of claim 1, further comprising executing a menu selected from the generated menu list.

8. The method of claim 7, wherein executing a menu comprises:
executing, when the menu is selected, an application screen applying at least one function of the at least one function element.

9. An apparatus having a menu generation interface, the apparatus comprising:
a display comprising a screen divided into a plurality of service item areas and a menu generation area; and
a controller to move at least one function element of the service item areas to the menu generation area in response to at least one user request, and to generate and display a menu list executable for the at least one function element in the menu generation area.

10. The apparatus of claim 9, wherein the controller extracts a relationship between a first function element and a second function element of the at least one function element, and generates a menu list executable according to the relationship.

11. The apparatus of claim 9, wherein the controller generates the menu list for the at least one function element when a movement complete signal for the at least one function element moved to the menu generation area is sensed.

12. The apparatus of claim 9, wherein a drag-and-drop signal corresponds to movement of the at least one function element to the menu generation area.

13. The apparatus of claim 9, wherein the at least one function element is moved to the menu generation area using an input of function key.

14. The apparatus of claim 9, wherein the controller displays the menu list within the menu generation area.

15. The apparatus of claim 9, wherein the controller executes a menu selected from the generated menu list.

16. The apparatus of claim 9, wherein the controller executes when the menu is selected, an application screen applying at least one function of the at least one function element in the menu generation area.
